(19) United States
(12) Patent Application Publication
(10) Pub. No.: US 2024/0283512 A1
(43) Pub. Date: Aug. 22, 2024

(54) METHOD AND DEVICE USED FOR WIRELESS COMMUNICATION

(71) Applicant: Xiaobo ZHANG, Shanghai (CN)

(72) Inventor: Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/625,218

(22) Filed: Apr. 3, 2024

Related U.S. Application Data
(63) Continuation of application No. PCT/CN2022/121556, filed on Sep. 27, 2022.

(30) Foreign Application Priority Data
Oct. 5, 2021 (CN) 202111173017.3

(51) Int. Cl. H04B 7/06

(52) U.S. Cl. CPC H04B 7/0626; H04B 7/0632

(57) ABSTRACT

The present invention discloses a method and a device for wireless communications. A first node receives a first configuration message group, the first configuration message group comprising at least one configuration message, any configuration message of the at least one configuration message comprising a first-type identifier and a reporting type, the first-type identifier being used to identify the configuration message to which the first-type identifier belongs; and transmits a first CSI report group, the first CSI report group comprising at least one CSI report, any CSI report in the first CSI report group being configured by a configuration message in the first configuration message group; where the priority of a first CSI report is related to whether a first configuration message comprises a first field. This application improves transmission efficiency, reduces redundancy overhead, and maintains good compatibility with existing systems.

### CROSS REFERENCE TO RELATED APPLICATIONS

This application is the continuation of the international patent application No. PCT/CN2022/121556, filed on Sep. 27, 2022, and claims the priority benefit of Chinese Patent Application No. 202111173017.3, filed on Oct. 5, 2021, the full disclosure of which is incorporated herein by reference.

### BACKGROUND

### Technical Field

The present application relates to methods and devices in wireless communication systems, and in particular to a scheme and device for CSI reporting in a wireless communication system.

### Related Art

In traditional wireless communication, the base station selects appropriate transmission parameters for the User Equipment (UE) based on the Channel Status Information (CSI) reported by the UE, such as Modulation and Coding Scheme (MCS), Transmitted Precoding Matrix Indicator (TPMI), Transmission Configuration Indication (TCI) and other parameters.

In the New Radio (NR) system, the priority of the CSI reports is defined, and the priority is used to determine whether to assign CSI Processing Unit (CPU) resources for updating corresponding CSI reports, or whether to drop the corresponding CSI reports.

### SUMMARY

In order to further improve the performance of Multi Input Multi Output (MIMO) systems. CSI schemes are continuously optimized. The inventors have found through researches that as more complex CSI calculation or reporting methods are proposed, the existing method of determining the priority of CSI reports may no longer be applicable.

To address the above problem, the present application provides a solution. It should be noted that while a large number of embodiments of the present application are described with respect to the priority of CSI reports in NR, the present application can also apply to the priority of CSI for other systems. In addition, the channel reconstruction schemes in the present application utilizing new technologies such as artificial intelligence (AI) are also applicable to conventional schemes based on linear channel reconstruction. Further, schemes that use a unified prioritization of CSI reports can reduce implementation complexity or improve performance. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:

receiving a first configuration message group, the first configuration message group comprising at least one configuration message, any configuration message of the at least one configuration message comprising a first-type identifier and a reporting type, the first-type identifier being used to identify the configuration message to which the first-type identifier belongs; and

transmitting a first CSI report group, the first CSI report group comprising at least one CSI report, any CSI report in the first CSI report group being configured by a configuration message in the first configuration message group:

herein, any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

In one embodiment, the above method adjusts the priority of the first CSI report according to the presence of the first field, such that the priority of the first CSI report can be flexibly adjusted as needed.

In one embodiment, the value of the first field can be freely set to bypass the priority already assigned to conventional CSI reports to better maintain compatibility.

Specifically, according to one aspect of the present application, the above method is characterized in that whether the first field is included in the first configuration message is related to the reporting type indicated by the first configuration message; when the reporting type indicated by the first configuration message is a candidate type in a first candidate type set, the first field is not included in the first configuration message; when the reporting type indicated by the first configuration message is a candidate type in a second candidate type set, the first field is included in the first configuration message; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

In one embodiment, the priorities associated with enhanced CSI and the priorities of conventional CSI reports in the above aspects are capable of being compared with each other, and thus maintain good compatibility with existing NR systems.

Typically, the first candidate type set comprises cri-RI-PMI-CQI, cri-RI-il, cri-RI-il-CQI, cri-RI-CQI, cri-RSRP, cri-SINR, ssb-Index-RSRP, ssb-Index-SINR, and cri-RI-LI-PMI-CQI.

In one embodiment, the first candidate type set comprises cri-SINR-r16 and ssb-Index-SINR-r16.

Specifically, according to one aspect of the present application, the above method is characterized in that when the first configuration message does not comprise the first field, the priority of the first CSI report is a first reference priority; when the first configuration message comprises the first field, the priority of the first CSI report is a first revision priority; the first revision priority is linearly related to the first parameter.

In one embodiment, the above method ensures flexible configuration of the belonging first revision priority.

Specifically, according to one aspect of the present application, the above method is characterized in that a linear coefficient of the priority of the first CSI report to the first parameter is configurable.

Specifically, according to one aspect of the present application, the above method is characterized in that a linear coefficient of the priority of the first CSI report to the first parameter is fixed.

Specifically, according to one aspect of the present application, the above method is characterized in that the reporting type of the first configuration message indicates a first reporting type; when the first configuration message comprises the first field, the first field in the first configuration message indicates a first reporting reference type, the first CSI report using one of the first reporting type or the first reporting reference type, the first parameter being associated with the first reporting reference type; when the first configuration message does not comprise the first field, the first CSI report uses the first reporting type.

The above method supports the switching of the first CSI report between at least two types, improving the performance of the CSI report.

Specifically, according to one aspect of the present application, the above method is characterized in that the first reporting reference type is a candidate type in the first candidate type set, while the first reporting type is a candidate type in the second candidate type set; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

Specifically, according to one aspect of the present application, the above method is characterized in comprising:
receiving reference signals in at least one RS resource set;
herein, each ReferenceSignal (RS) resource set of the at least one RS resource set comprises at least one RS resource, and any CSI report in the first CSI report group is based on a measurement of one RS resource set of the at least one RS resource set.

In one embodiment, an RS resource set comprises at least one CSI-RS resource.

In one embodiment, an RS resource set is indicated by a CSI-ResourceConfigId.

In one embodiment, an RS resource set comprises at least one of a CSI-RS resource set or an SS/PBCH block (SSB) resource set.

In one embodiment, an RS resource set comprises at least one of SSB resources configured by a CSI-SSB-ResourceSet or CSI-RS resources configured by an NZP-CSI-RS-ResourceSet.

Specifically, according to one aspect of the present application, the above method is characterized in that any configuration message of the at least one configuration message includes a transmission mode, where candidates for the transmission mode include periodic, semi-persistent and aperiodic; any configuration message of the at least one configuration message explicitly or implicitly indicates a cell index, the cell index indicating a cell occupied by an RS resource set indicated by the corresponding configuration message.

In one embodiment, when a configuration message implicitly indicates a cell index, an index of a serving cell occupied by the transmission of the configuration message is indicated.

The present application provides a method in a second node for wireless communications, comprising:
transmitting a first configuration message group, the first configuration message group comprising at least one configuration message, any configuration message of the at least one configuration message comprising a first-type identifier and a reporting type, the first-type identifier being used to identify the configuration message to which the first-type identifier belongs; and
receiving a first CSI report group, the first CSI report group comprising at least one CSI report, any CSI report in the first CSI report group being configured by a configuration message in the first configuration message group;
herein, any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

Specifically, according to one aspect of the present application, the above method is characterized in that whether the first field is included in the first configuration message is related to the reporting type indicated by the first configuration message; when the reporting type indicated by the first configuration message is a candidate type in a first candidate type set, the first field is not included in the first configuration message; when the reporting type indicated by the first configuration message is a candidate type in a second candidate type set, the first field is included in the first configuration message; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

Specifically, according to one aspect of the present application, the above method is characterized in that when the first configuration message does not comprise the first field, the priority of the first CSI report is a first reference priority; when the first configuration message comprises the first field, the priority of the first CSI report is a first revision priority; the first revision priority is linearly related to the first parameter.

Specifically, according to one aspect of the present application, the above method is characterized in that a linear coefficient of the priority of the first CSI report to the first parameter is configurable, or, a linear coefficient of the priority of the first CSI report to the first parameter is fixed.

Specifically, according to one aspect of the present application, the above method is characterized in that the reporting type of the first configuration message indicates a first reporting type; when the first configuration message comprises the first field, the first field in the first configuration message indicates a first reporting reference type, the first CSI report using one of the first reporting type or the first reporting reference type, the first parameter being associated with the first reporting reference type; when the first configuration message does not comprise the first field, the first CSI report uses the first reporting type.

Specifically, according to one aspect of the present application, the above method is characterized in that the first reporting reference type is a candidate type in the first candidate type set, while the first reporting type is a candidate type in the second candidate type set; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

Specifically, according to one aspect of the present application, the above method comprises:
transmitting reference signals in at least one RS resource set;
herein, each RS resource set of the at least one RS resource set comprises at least one RS resource, and any CSI report in the first CSI report group is based on a measurement of one RS resource set of the at least one RS resource set.

Specifically, according to one aspect of the present application, the above method is characterized in that any configuration message of the at least one configuration message includes a transmission mode, where candidates for the transmission mode include periodic, semi-persistent and aperiodic; any configuration message of the at least one configuration message explicitly or implicitly indicates a cell index, the cell index indicating a cell occupied by an RS resource set indicated by the corresponding configuration message.

The present application provides a first node for wireless communications, comprising:
a first receiver, receiving a first configuration message group, the first configuration message group comprising at least one configuration message, any configuration message of the at least one configuration message comprising a first-type identifier and a reporting type, the first-type identifier being used to identify the configuration message to which the first-type identifier belongs; and
a first transmitter, transmitting a first CSI report group, the first CSI report group comprising at least one CSI report, any CSI report in the first CSI report group being configured by a configuration message in the first configuration message group;
herein, any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

The present application provides a second node for wireless communications, comprising:
a second transmitter, transmitting a first configuration message group, the first configuration message group comprising at least one configuration message, any configuration message of the at least one configuration message comprising a first-type identifier and a reporting type, the first-type identifier being used to identify the configuration message to which the first-type identifier belongs; and
a second receiver, receiving a first CSI report group, the first CSI report group comprising at least one CSI report, any CSI report in the first CSI report group being configured by a configuration message in the first configuration message group;
herein, any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

### BRIEF DESCRIPTION OF THE DRAWINGS

Other features, objects and advantages of the present invention will become more apparent from the detailed description of non-restrictive embodiments taken in conjunction with the following drawings:

FIG. 1 illustrates a flowchart of transmitting a first configuration message group and a first CSI report group according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of hardcore modules in a communication node according to one embodiment of the present application.

FIG. 5 illustrates a flowchart of transmission between a first node and a second node according to one embodiment of the present application.

FIG. 6 illustrates a schematic diagram of a first original CSI, a first CSI and a first recovered CSI according to one embodiment of the present application.

FIG. 7 illustrates a schematic diagram of a first encoder according to one embodiment of the present application.

FIG. 8 illustrates a schematic diagram of a first function according to one embodiment of the present application.

FIG. 9 illustrates a schematic diagram of a decoding layer group according to one embodiment of the present application.

FIG. 10 illustrates a structure block diagram of a processing device used in a first node according to one embodiment of the present application.

FIG. 11 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

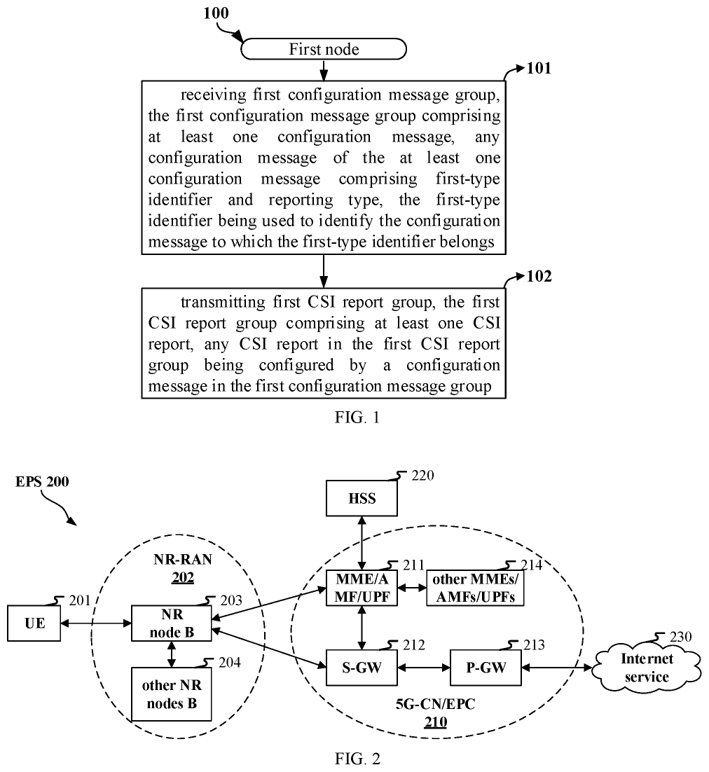

Embodiment 1 illustrates a flowchart of transmitting a first configuration message group and a first CSI report group according to one embodiment of the present application, as shown in FIG. 1.

The first node 100 receives a first configuration message group in step 101, the first configuration message group comprising at least one configuration message, any configuration message of the at least one configuration message comprising a first-type identifier and a reporting type, the first-type identifier being used to identify the configuration message to which the first-type identifier belongs; and transmits a first CSI report group in step 102, the first CSI report group comprising at least one CSI report, any CSI report in the first CSI report group being configured by a configuration message in the first configuration message group.

In Embodiment 1, any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

Typically, the first configuration message group is Radio Resource Control (RRC) layer signaling.

In one embodiment, the transmitter of the first configuration message group determines for itself whether the first field is included in the first configuration message.

In one embodiment, the first-type identifier is a non-negative integer.

In one embodiment, the first-type identifier is an index of a corresponding configuration message.

In one embodiment, among configuration messages configured to a BandWidth Part (BWP), the first-type identifier uniquely identifies a configuration message.

In one embodiment, among configuration messages configured to a serving cell, the first-type identifier uniquely identifies a configuration message.

In one embodiment, the first configuration message group is an Information Element (IE) and the name of the first configuration message group includes csi-ReportConfigToAddModList.

In one embodiment, the first configuration message group is a csi-ReportConfigToAddModList IE.

In one embodiment, the first configuration message group is a CSI-AperiodicTriggerStateList.

In one embodiment, each configuration message in the first configuration message group is an IE, and the name of each configuration message in the first configuration message group includes CSI-ReportConfig.

In one embodiment, each configuration message in the first configuration message group is a CSI-ReportConfig IE, the first-type identifier being a reportConfigId.

In one embodiment, each configuration message in the first configuration message group is a CSI-ReportConfig IE, the first-type identifier being a CSI-ReportConfigId.

In one subembodiment of the above two embodiments, the name of the reporting type includes reportQuantity.

In one subembodiment of the above two embodiments, the reporting type is reportQuantity or reportQuantity-r16.

In one subembodiment of the above two embodiments, the reporting type is one of reportQuantity, reportQuantity-r16 or reportQuantity-r18.

In one subembodiment of the above two embodiments, the reporting type is one of reportQuantity, reportQuantity-r16 or reportQuantity-r19.

In one embodiment, the number of configuration messages included in the first configuration message group does not exceed 48, and the first-type identifier is a non-negative integer not greater than 47.

In one embodiment, RS resources targeted, a band targeted, a channel resource occupied and a type of CSIs included by a CSI report are configured by corresponding configuration messages.

In one embodiment, time-frequency resources occupied by a CSI report are configured by a corresponding configuration message.

Typically, the smaller the priority is, the higher the level of the priority is; the priorities of any two configuration messages in the first configuration message group are different.

In one embodiment, the priority has a value range of non-negative integers not greater than 12287.

The above embodiments are advantageous in being as compatible as possible with the priority of CSI reports in existing NR systems, with good compatibility.

In one embodiment, the priority of any CSI report in the first CSI report group is a non-negative integer no greater than 12287.

In one embodiment, the first CSI report group is transmitted on a physical layer channel.

In one embodiment, each CSI report in the first CSI report group is transmitted on a physical layer channel, and at least two CSI reports in the first CSI report group are transmitted on different physical layer channels.

In one embodiment, the physical layer channel is a Physical Uplink Shared CHannel (PUSCH) or a Physical Uplink Control CHannel (PUCCH).

In one embodiment, in case of insufficiency of unoccupied CSI Processing Units (CPUs), the update of higher priority CSI reports is guaranteed.

In one embodiment, the first CSI report group comprises N CSI reports. N being a positive integer greater than 1: if updated, the N CSI reports all start to occupy CPU from a first multicarrier symbol; and for any of the N CSI reports, if the total number of CPUs occupied by CSI reports with higher priority among the N CSI reports is not less than a first threshold, then any such CSI report of the N CSI reports is not required to be updated.

In one embodiment, reference is made to section 5.2.1.6 of the 3rd Generation Partnership Project (3GPP) TS38.214 for more description of the guaranteed updating of higher priority CSI reports.

In one embodiment, a higher priority CSI report is sent and a lower priority CSI report is dropped when there is insufficient capacity in the physical layer channel.

In one embodiment, reference is made to section 5.2.3 of TS 38.214 for more description of dropping lower priority CSI reports.

Typically, the multicarrier symbol is an Orthogonal Frequency Division Multiplexing (OFDM) Symbol.

In one embodiment, the first multicarrier symbol is a Single Carrier-Frequency Division Multiple Access (SC-FDMA) symbol.

In one embodiment, the first multicarrier symbol is a Discrete Fourier Transform Spread OFDM (DFT-S-OFDM) symbol.

In one embodiment, the first multicarrier symbol is a Filter Bank Multi Carrier (FBMC) symbol.

In one embodiment, the first multicarrier symbol comprises a Cyclic Prefix (CP).

### Embodiment 2

Embodiment 2 illustrates a schematic diagram of a network architecture according to one embodiment of the present application, as shown in FIG. 2. FIG. 2 illustrates an architecture of 5G New Radio (NR). Long-Term Evolution (LTE) and Long-Term Evolution Advanced (LTE-A) systems. The 5G NR or LTE network architecture 200 may be called a 5G System/Evolved Packet System (5GS/EPS) or other suitable terminology. The EPS 200 may comprise one UE 201, an NG-RAN 202, an Evolved Packet Core/5G-Core Network (EPC-5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones. Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet. Intranet. IP Multimedia Subsystem (IMS) and Packet Switching Streaming (PSS) services.

In one embodiment, the UE 201 corresponds to the first node in the present application, and the gNB203 corresponds to the second node in the present application.

In one embodiment, the UE201 supports the generation of CSI taking advantage of Artificial Intelligence (AI) or Deep Learning.

Typically, the generation of CSI includes compressing CSI.

In one embodiment, the UE201 supports the determination of at least part of parameters of Conventional Neural Networks (CNN) for CSI reconstruction through training.

In one embodiment, the UE 201 is a terminal supporting Massive-MIMO.

In one embodiment, the gNB203 supports Massive-MIMO-based transmission.

In one embodiment, the gNB203 supports the decompression of CSI taking advantage of AI or Deep Learning.

In one embodiment, the gNB 203 is a MacroCellular base station.

In one embodiment, the gNB203 is a Micro Cell base station.

In one embodiment, the gNB 203 is a PicoCell base station.

In one embodiment, the gNB203 is a Femtocell.

In one embodiment, the gNB203 is a base station supporting large time-delay difference.

In one embodiment, the gNB203 is a flight platform.

In one embodiment, the gNB203 is satellite equipment.

In one embodiment, the first node and the second node in the present application are respectively the UE201 and the gNB203.

### Embodiment 3

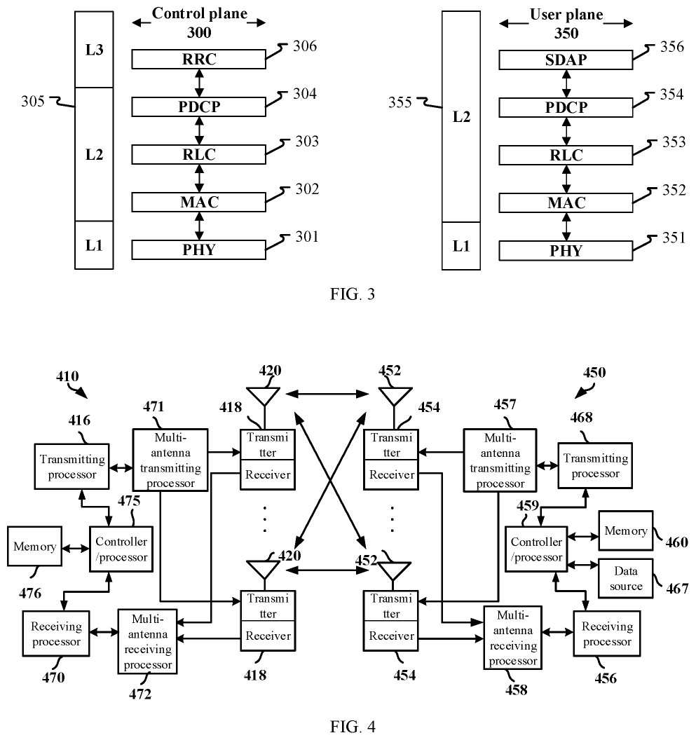

Embodiment 3 illustrates a schematic diagram of an embodiment of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, or RSU in V2X, vehicle-mounted equipment or vehicle-mounted communication module) and a second node (gNB. UE, or RSU in V2X, vehicle-mounted equipment or vehicle-mounted communication module), or between two UEs is represented by three layers, which are: layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides data encryption and integrity protection, and the PDCP sublayer 304 also provides support for inter-cell mobility of the second node between first nodes. The RLC sublayer 303 provides packet segmentation and reassembly, retransmission of a lost packet via ARQ, and it also provides duplicate packet detection and protocol error detection. The MAC sublayer 302 provides mapping between the logical and transport channels and multiplexing of logical channels. The MAC sublayer 302 is also responsible for allocating between first nodes various radio resources (i.e., resource block) in a cell. The MAC sublayer 302 is also in charge of HARQ operation. In the control plane 300. The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several upper layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the CSI report in the present application is generated by the PHY 301.

In one embodiment, the first configuration message in the present application is generated by the RRC sublayer 306.

In one embodiment, the measurement of RS resources in the present application is performed at the PHY 301.

### Embodiment 4

Embodiment 4 illustrates a schematic diagram of hardcore modules in a communication node according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs channel coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 de-interleaves and channel decodes the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device (node) 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs channel coding, interleaving and modulation and mapping, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first configuration message group, the first configuration message group comprising at least one configuration message, any configuration message of the at least one configuration message comprising a first-type identifier and a reporting type, the first-type identifier being used to identify the configuration message to which the first-type identifier belongs; and transmits a first CSI report group, the first CSI report group comprising at least one CSI report, any CSI report in the first CSI report group being configured by a configuration message in the first configuration message group: herein, any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

In one embodiment, the first communication device 450 comprises a memory that stores a computer readable instruction program. The computer readable instruction program generates actions when executed by at least one processor. The actions include: receiving the first configuration message group; and transmitting the first CSI report group.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits the first configuration message group; and receives the first CSI report group.

In one embodiment, the second communication device 410 comprises a memory that stores a computer readable instruction program. The computer readable instruction program generates actions when executed by at least one processor. The actions include: transmitting the first configuration message group; and receiving the first CSI report group.

In one embodiment, the first communication device 450 corresponds to the first node in the present application.

In one embodiment, the second communication device 410 corresponds to the second node in the present application.

In one embodiment, the first communication device 450 is a UE, and the second communication device 410 is a base station.

In one embodiment, the antenna 452, the receiver 454, the multi-antenna receiving processor 458, the receiving processor 456, and the controller/processor 459 are used for receiving the first configuration message group.

In one embodiment, the antenna 452, the receiver 454, the multi-antenna receiving processor 458, the receiving processor 456, and the controller/processor 459 are used for receiving reference signals in RS resources.

In one embodiment, the antenna 452, the transmitter 454, the multi-antenna transmitting processor 457, the transmitting processor 468, and the controller/processor 459 are used for transmitting the first CSI report group.

In one embodiment, the antenna 420, the transmitter 418, the multi-antenna transmitting processor 471, the transmitting processor 416, and the controller/processor 475 are used for transmitting the first configuration message group.

In one embodiment, the antenna 420, the transmitter 418, the multi-antenna transmitting processor 471, the transmitting processor 416, and the controller/processor 475 are used for transmitting reference signals in RS resources.

In one embodiment, the antenna 420, the receiver 418, the multi-antenna receiving processor 472, the receiving processor 470, and the controller/processor 475 are used for receiving the first CSI report group.

### Embodiment 5

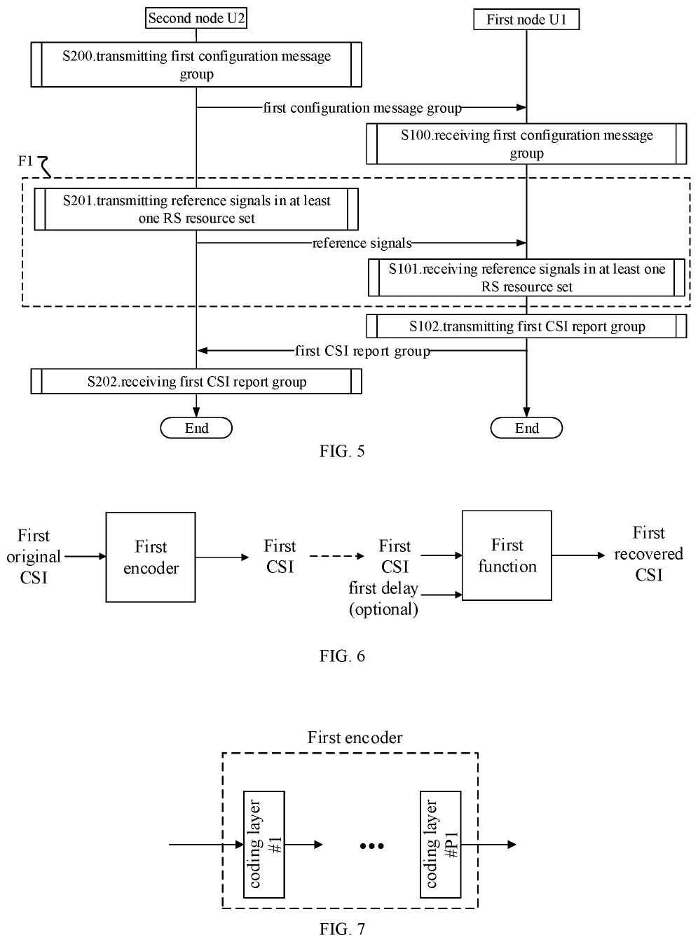

Embodiment 5 illustrates a flowchart of transmission between a first node and a second node according to one embodiment of the present application, as shown in FIG. 5. In FIG. 5, steps marked by the box F1 are optional, respectively.

The first node U1 receives a first configuration message group in step S100, the first configuration message group comprising at least one configuration message, any configuration message of the at least one configuration message comprising a first-type identifier and a reporting type, the first-type identifier being used to identify the configuration message to which the first-type identifier belongs; and receives reference signals in at least one RS resource set in step S101, each RS resource set of the at least one RS resource set comprises at least one RS resource, and any CSI report in the first CSI report group is based on a measurement of one RS resource set of the at least one RS resource set; and transmits a first CSI report group in step S102, the first CSI report group comprising at least one CSI report, any CSI report in the first CSI report group being configured by a configuration message in the first configuration message group.

The second node U2 transmits the first configuration message group in step S200; and transmits reference signals in the at least one RS resource set in step S201; and receives the first CSI report group in step S202.

In Embodiment 5, any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

In one embodiment, candidates for the reporting type include cri-RI-PMI-CQI, cri-RI-il, cri-RI-il-CQI, cri-RI-CQI, cri-RSRP, cri-SINR, ssb-Index-RSRP, ssb-Index-SINR, cri-RI-LI-PMI-CQI, cri-SINR-r16 and ssb-Index-SINR-r16.

In one embodiment, whether the first field is included in the first configuration message is related to the reporting type indicated by the first configuration message; when the reporting type indicated by the first configuration message is a candidate type in a first candidate type set, the first field is not included in the first configuration message; when the reporting type indicated by the first configuration message is a candidate type in a second candidate type set, the first field is included in the first configuration message; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

An advantage of the above embodiment is that the priorities of different reporting types can be compared with each other, thus maintaining better compatibility with existing NR systems.

In one embodiment, the first candidate type set comprises cri-RI-PMI-CQI, cri-RI-il, cri-RI-il-CQI, cri-RI-CQI, cri-RSRP, cri-SINR, ssb-Index-RSRP, ssb-Index-SINR, and cri-RI-LI-PMI-CQI.

In one embodiment, the first candidate type set comprises cri-SINR-r16 and ssb-Index-SINR-r16.

Typically, the second candidate type set comprises at least one candidate type, with a CSI report configured by each candidate type of the at least one candidate type comprising CSIs that have been generated utilizing AI or deep learning.

Typically, the CSIs generated by utilizing AI or deep learning has a lower redundancy overhead compared to conventional CSIs.

In one embodiment. CSI report(s) configured by one or more of the at least one candidate type comprises CSIs generated utilizing AI or deep learning as well as conventional CSIs.

In one embodiment, the AI includes Conventional Neural Networks (CNN).

In one embodiment, the second candidate type set comprises at least one candidate type, with a CSI report configured by each candidate type of the at least one candidate type comprising CSIs that have been through non-linear coding.

Conventional CSI is essentially obtained after the received reference signal has been subjected to linear operations including quantization, such as L1-RSRP/RSRQ, CRI, RI, LI, PMI, CQI, whereas non-linear coding may yield additional gains in terms of reduced redundancy overhead, feedback accuracy, etc.

In one embodiment, the CSIs that have been through non-linear coding are obtained by the original CSI through a non-linear encoder, the original CSI being a channel parameter obtained by means of conventional techniques.

In one embodiment, the original CSI comprises a channel impulse response.

In one embodiment, the original CSI comprises at least one of a CSI reference signal received power (CSI-RSRP), a CSI reference signal received Quality (CSI-RSRQ), a CSI signal-to-noise and interference ratio (CSI-SINR), an SS reference signal received power (SS-RSRP), an SS reference signal received quality (SS-RSRQ), or an SS signal-to-noise and interference ratio (SS-SINR).

In one embodiment, the original CSI comprises at least one of a CSI-RS Resource Indicator (CRI), a Rank Indicator (RI), a Precoding Matrix Indicator (PMI) or a Channel quality indicator (CQI).

In one embodiment, steps in the box F1 occur after the step S100 and the step S200.

In one embodiment, steps in the box F1 occur before the step S100 and the step S200.

Typically, the first field in the first configuration message explicitly indicates the first parameter, or, the first field in the first configuration message implicitly indicates the first parameter.

In one embodiment, the above method is characterized in that when the first configuration message does not comprise the first field, the priority of the first CSI report is a first reference priority; when the first configuration message comprises the first field, the priority of the first CSI report is a first revision priority; the first revision priority is linearly related to the first parameter.

Typically, a range of values of the first revision priority is the same as a range of values of the first reference priority.

In one embodiment, the first revision priority is equal to the first parameter.

In one embodiment, the first revision priority is equal to a sum of a first bias plus the first reference priority, the first bias being linearly related to the first parameter.

In one embodiment, a linear coefficient of the first revision priority to the first parameter is configurable.

In one embodiment, a linear coefficient of the first revision priority to the first parameter is a fixed constant (i.e. non-configurable).

In one embodiment, maxNrofServingCells is used to indicate the linear coefficient of the first revision priority to the first parameter.

In one embodiment, maxNrofCSI-ReportConfigurations is used to indicate the linear coefficient of the first revision priority to the first parameter.

In one embodiment, the linear coefficient of the first revision priority to the first parameter is a product of Ms and Ncells, the Ms and Ncells being indicated by maxNrofCSI-ReportConfigurations and maxNrofServingCells, respectively.

In one embodiment, the first reference priority is:

$${Pri}_{iCSI} ( y , k , c , s ) = 2 \cdot {N}_{cells} \cdot {M}_{s} \cdot y + {N}_{cells} {M}_{s} \cdot k + {M}_{s} \cdot c + s$$

where y, k, c, s are respectively related to a transmission method in the first configuration message, the reporting type in the first configuration message, a cell index indicated by the first configuration message, and the first-type identifier in the first configuration message.

In one embodiment, when a transmission method in the first configuration message indicates that the first CSI report is periodic (or periodically carried on a PUCCH), or semi-persistently carried on a PUCCH, or semi-persistently carried on a PUSCH, or aperiodic (or non-periodically carried on a PUSCH), y takes the value of 3, 2, 1, 0, respectively: k is 0 when the reporting type in the first configuration message indicates that the first CSI report includes L1-RSRP or L1-SINR, and k is 1 when the reporting type in the first configuration message indicates that the first CSI report does not include L1-RSRP or L1-SINR: c is a cell index indicated by the first configuration message, s is the first-type identifier in the first configuration message; N_{cells} and Mₛ are parameters configured by higher layers, respectively.

In one subembodiment of the above embodiment, N_{cells} and M are maxNrofServingCells and maxNrofCSI-ReportConfigurations, respectively.

In one embodiment, the first revision priority is:

$$2 \cdot {N}_{cells} \cdot {M}_{s} \cdot y + {N}_{cells} \cdot {M}_{s} \cdot ( k + k 1 ) + \cdot c + s$$

where k1 is the first parameter.

In one embodiment, the range of values of k1 includes the decimal.

In one embodiment, the range of values of k1 includes the negative numbers.

In one embodiment, the first revision priority is:

$$2 \cdot {N}_{cells} \cdot {M}_{s} \cdot y + {N}_{cells} \cdot {M}_{s} \cdot k + {M}_{s} \cdot c + s + P$$

where P is the first parameter.

In one embodiment. P is an integer, and the range of values of P includes the negative numbers.

In one embodiment, a linear coefficient of the priority of the first CSI report to the first parameter is configurable.

In one embodiment, a linear coefficient of the priority of the first CSI report to the first parameter is fixed.

In one embodiment, the linear coefficient of the priority of the first CSI report to the first parameter is fixed (i.e., non-configurable) to 1.

In one embodiment, the reporting type of the first configuration message indicates a first reporting type; when the first configuration message comprises the first field, the first field in the first configuration message indicates a first reporting reference type, the first CSI report using one of the first reporting type or the first reporting reference type, the first parameter being associated with the first reporting reference type; when the first configuration message does not comprise the first field, the first CSI report uses the first reporting type.

In the above embodiment, for the first reporting type having been given, a first reporting reference type may vary among a plurality of candidate types, thereby causing a change of the first parameter.

In one embodiment, the first reporting reference type is a candidate type in the first candidate type set, and the priority of the first CSI report is calculated using the method of calculating the first reference priority, where the first parameter is the k determined based on the first reporting reference type.

In one embodiment, when a CSI report indicated by the first reporting reference type includes L1-RSRP or L1-SINR, the first parameter is 0; when a CSI report indicated by the first reporting reference type does not include L1-RSRP or L1-SINR, the first parameter is 1; the priority of the first CSI report and the first parameter are linearly related.

In one embodiment, when the first configuration message comprises the first field, the first node itself determines whether the first CSI report employs the first reporting type or the first reporting reference type.

In one subembodiment, the first CSI report indicates whether the first CSI report employs the first reporting type or the first reporting reference type.

In one embodiment, the first receiver receives a first signaling:
herein, the first signaling indicates whether the first CSI report employs the first reporting type or the first reporting reference type.

In one embodiment, the first signaling is a Medium Access Control (MAC) Control Element (CE).

In one embodiment, the first signaling is a piece of Downlink Control Information (DCI).

In one embodiment, the first reporting reference type implicitly indicates the first parameter.

In one embodiment, the first reporting reference type is a candidate type in the first candidate type set.

In one embodiment, candidates for the first reporting reference type include at least one of cri-SINR, ssb-Index-SINR, cri-SINR-r16 or ssb-Index-SINR-r16.

In one embodiment, candidates for the first reporting reference type include at least one of cri-RI-PMI-CQI, cri-RI-il, cri-RI-il-CQI, cri-RI-CQI or cri-RI-LI-PMI-CQI.

In one embodiment, candidates for the first reporting reference type include at least one of cri-SINR, ssb-Index-SINR, cri-SINR-r16, or ssb-Index-SINR-r16, and also include at least one of cri-RI-PMI-CQI, cri-RI-il, cri-RI-il-CQI, cri-RI-CQI or cri-RI-LI-PMI-CQI.

In one embodiment, the first parameter is one of 0 or 1.

Typically, the first reporting reference type is a candidate type in the first candidate type set, while the first reporting type is a candidate type in the second candidate type set; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

In one embodiment, when the first reporting reference type indicates that the first CSI report includes L1-RSRP or L1-SINR, the first parameter is 0; when the first reporting reference type indicates that the first CSI report does not include L1-RSRP or L1-SINR, the first parameter is 1.

In one embodiment, when the first reporting reference type is one of cri-RSRP, cri-SINR, ssb-Index-RSRP, or ssb-Index-SINR, the first parameter is 0; when the first reporting reference type is one of cri-RI-PMI-CQI, cri-RI-il, cri-RI-il-CQI, cri-RI-CQI, or cri-RI-LI-PMI-CQI, the first parameter is 1.

In one embodiment, any configuration message of the at least one configuration message includes a transmission mode, where candidates for the transmission mode include periodic, semi-persistent and aperiodic; any configuration message of the at least one configuration message explicitly or implicitly indicates a cell index, the cell index indicating a cell occupied by an RS resource set indicated by the corresponding configuration message.

Typically, a set of RS resources comprises at least one CSI-RS resource or at least one SSB indicated by the ssb-index.

In one embodiment, the transmission method is reportConfigType, which includes aperiodic and aperiodic, respectively; the semi-persistent includes semiPersistentOnPUCCH and semiPersistentOnPUSCH; and a CSI-ResourceConfigId in a configuration message is used to indicate an index of a set of RS resources.

In one embodiment, if a configuration message includes a carrier, the carrier explicitly indicates the cell index, and if a configuration message does not include a carrier, a serving cell to which the Physical Downlink Shared CHannel (PDSCH) occupied by the configuration message belongs is implicitly indicated.

### Embodiment 6

Embodiment 6 illustrates a schematic diagram of a first original CSI, a first CSI and a first recovered CSI according to one embodiment of the present application, as shown in FIG. 6. In FIG. 6, the input of a first encoder comprises at least the first original CSI, the first original CSI being typically obtained by the first node going through at least channel estimation; the output of the first encoder comprises the first CSI; the first CSI is reported to a receiver via an air interface; the input of a first function comprises at least the first CSI, and the output of the first function comprises the first recovered CSI. The second candidate type set in this application comprises at least one candidate type by which a CSI report configured comprises the first CSI.

In Embodiment 6, the first encoder is established at a first node, while the first function is established at a second node, or is established both at the first node and at the second node. The first encoder is used to compress the first original CSI in order to reduce the air interface overhead of the first CSI, and the first function is used to decompress the first CSI in order to ensure, as far as possible, that the first recovered CSI accurately reflects the actual channel characteristics, and thus the first function may also be referred to as a decoder.

In one embodiment, the first configuration message comprises the first field, and the first CSI is part of the first CSI report in this application.

In one embodiment, at least part of parameters of the first function are obtained by training on the side of the first node and are indicated to the second node by the first node via a second signaling.

In one embodiment, the first function is linear, e.g. Wiener filtering, two X one-dimensional filtering and the like.

In one embodiment, both the first encoder and the first function are non-linear.

In one embodiment, the first encoder box and the first function are implemented based on a CRnet encoder and a CRnet decoder, respectively, as described in detail with reference to Zhilin Lu, Multi-resolution CSI Feedback with Deep Learning in Massive MIMO System, 2020 IEEE International Conference on Communications (ICC).

In one embodiment. (without taking into account a first delay) the optimization objective of the first function includes minimizing an error between the first recovered CSI and the first original CSI, such as Mean Square Error (MSE) and Linear Minimum Mean Square Error (LMMSE).

In scenarios where channel changes are slow, the above method can simplify the design of the first function and reduce complexity.

In one embodiment, the input of the first function comprises a first delay, the first delay being described with reference to Embodiment 8.

The introduction of a first delay has the advantage of making the first recovered CSI reflect the channel characteristics on time-frequency resource being scheduled more accurately, but at a cost that the design of the first function may get more complex (e.g. an additional module for CSI prediction may be required).

In one embodiment, the first original CSI comprises a frequency-domain channel impulse response.

In one embodiment, the first original CSI comprises a time-domain channel impulse response.

In one embodiment, the first original CSI comprises at least one of a CSI reference signal received power (CSI-RSRP), a CSI reference signal received Quality (CSI-RSRQ), a CSI signal-to-noise and interference ratio (CSI-SINR), an SS reference signal received power (SS-RSRP), an SS reference signal received quality (SS-RSRQ), or an SS signal-to-noise and interference ratio (SS-SINR).

In one embodiment, the first original CSI comprises at least one of a CSI-RS Resource Indicator (CRI), a Rank Indicator (RI), a Precoding Matrix Indicator (PMI) or a Channel quality indicator (CQI).

In one embodiment, the second candidate type set in this application comprises at least one candidate type by which a CSI report configured comprises conventional CSI and the first CSI.

In one embodiment, the conventional CSI comprises at least one of a CRI or a Layer Indicator (LI), and the first original CSI comprises a channel impulse response.

In one embodiment, the conventional CSI comprises at least one of a CRI, a LI or a CQI, and the first original CSI comprises a channel impulse response.

In one embodiment, the conventional CSI comprises at least one of a CRI, a Layer Indicator (LI), a RI or a CQI, and the first original CSI comprises a channel impulse response.

An advantage of the several embodiments described above is that the first CSI is utilized to provide more accurate channel information than conventional PMI (and/or RI. CQI), which in turn improves the transmission performance. In addition, the several embodiments described above can make full use of existing standards/hardware capabilities and have good compatibility.

### Embodiment 7

Embodiment 7 illustrates a schematic diagram of a first encoder according to one embodiment of the present application, as shown in FIG. 7. In FIG. 7, the first encoder comprises P1 coding layers, namely, coding layers #1, #2 . . . , and #P1.

In one embodiment, P1 is 2, namely, the P1 coding layers include a coding layer #1 and a coding layer #2, the coding layer #1 and the coding layer #2 respectively being a Convolution layer and a Fully Connected layer; at the Convolution layer, at least one convolutional kernel is used for convoluting a first original CSI for generating corresponding feature map(s), and at least one feature map output by the convolution layer is/are reshaped as a vector to be input to the Fully Connected layer; the Fully Connected layer converts the above vector into the first CSI. A more detailed description can be found in the technical literature related to CNNs, for example. Chao-Kai Wen. Deep Learning for Massive MIMO CSI Feedback, IEEE WIRELESS COMMUNICATIONS LETTERS, VOL. 7, NO. 5, OCTOBER 2018, etc.

In one embodiment, P1 is 3, namely, the P1 coding layers are respectively a Fully Connected layer, a Convolution layer and a Pooling layer.

### Embodiment 8

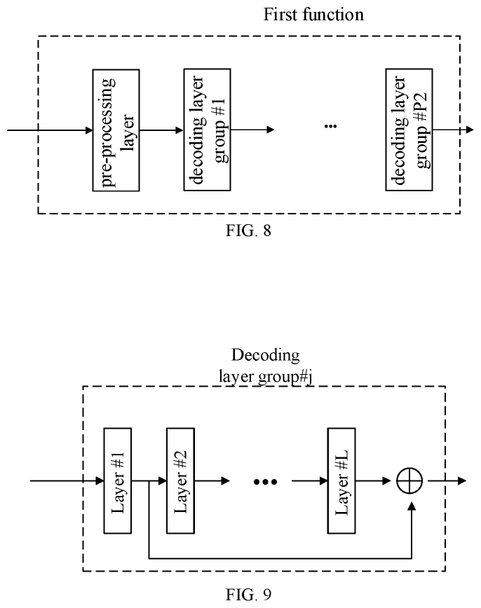

Embodiment 8 illustrates a schematic diagram of a first function according to one embodiment of the present application, as shown in FIG. 8. In FIG. 8, the first function comprises a pre-processing layer, as well as P2 decoding layer groups, i.e., decoding layer groups #1, #2 . . . and #P2, where each decoding layer group comprises at least one decoding layer.

According to conventional CSI processing algorithms, the first CSI can be considered to be obtained by quantization of the sampling of the first original CSI in time or frequency domain; accordingly, the first function is linear, e.g. in interpolating and filtering the first CSI in time or frequency domain to obtain the first recovered CSI.

In addition to the first function described above, which is linear, the following embodiments describe the implementation of a non-linear function.

In one embodiment, the pre-processing layer is a Fully Connected layer, which is to expand a size of the first CSI to a size of the first original CSI

In one embodiment, any two decoding layer groups among the P2 decoding layer groups have identical structures, where the structure comprises a number of decoding layers being comprised, as well as the size of an input parameter and the size of an output parameter of each decoding layer being comprised.

In one embodiment, a second node indicates the P2 and the structure of the decoding layer groups to a first node, and the first node indicates other parameters of the first function via the second signaling.

In one embodiment, the other parameters include at least one of a threshold of activation function, a size of convolutional kernel, a step-size of convolutional kernel, or a weight among feature maps.

### Embodiment 9

Embodiment 9 illustrates a schematic diagram of a decoding layer group according to one embodiment of the present application, as shown in FIG. 9. In FIG. 9, the decoding layer group #j consists of L layers. i.e., layer #1, layer #2 . . . , and layer #L; the decoding layer group is any decoding layer group among the P2 decoding layer groups.

In one embodiment. L is 4; a first layer among the L layers is an input layer, while the last three of them are convolution layers: for more detailed descriptions, refer to technical literature of CNN, for instance. Chao-Kai Wen, Deep Learning for Massive MIMO CSI Feedback, IEEE WIRELESS COMMUNICATIONS LETTERS, VOL. 7, NO. 5, OCTOBER 2018, etc.

In one embodiment, the L layers include at least one convolution layer and a pooling layer.

### Embodiment 10

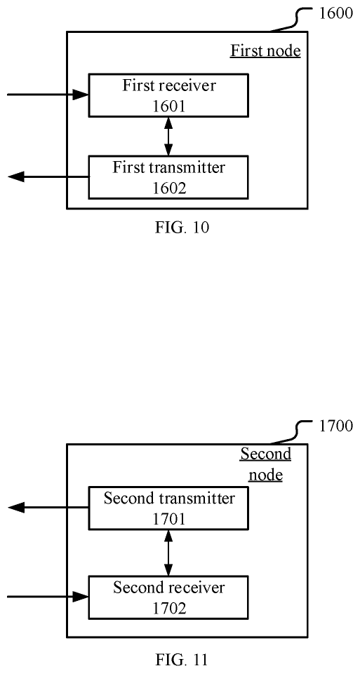

Embodiment 10 illustrates a structure block diagram of a processing device used in a first node according to one embodiment of the present application, as shown in FIG. 10. In FIG. 10, a processing device 1600 in a first node is comprised of a first receiver 1601 and a first transmitter 1602.

The first receiver 1601 receives a first configuration message group, the first configuration message group comprising at least one configuration message, any configuration message of the at least one configuration message comprising a first-type identifier and a reporting type, the first-type identifier being used to identify the configuration message to which the first-type identifier belongs; the first transmitter 1602 transmits a first CSI report group, the first CSI report group comprising at least one CSI report, any CSI report in the first CSI report group being configured by a configuration message in the first configuration message group.

In Embodiment 10, any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

In one embodiment, whether the first field is included in the first configuration message is related to the reporting type indicated by the first configuration message; when the reporting type indicated by the first configuration message is a candidate type in a first candidate type set, the first field is not included in the first configuration message; when the reporting type indicated by the first configuration message is a candidate type in a second candidate type set, the first field is included in the first configuration message; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

In one embodiment, the above method is characterized in that when the first configuration message does not comprise the first field, the priority of the first CSI report is a first reference priority; when the first configuration message comprises the first field, the priority of the first CSI report is a first revision priority; the first revision priority is linearly related to the first parameter.

In one embodiment, the above method is characterized in that a linear coefficient of the priority of the first CSI report to the first parameter is configurable, or, a linear coefficient of the priority of the first CSI report to the first parameter is fixed.

In one embodiment, the reporting type of the first configuration message indicates a first reporting type; when the first configuration message comprises the first field, the first field in the first configuration message indicates a first reporting reference type, the first CSI report using one of the first reporting type or the first reporting reference type, the first parameter being associated with the first reporting reference type; when the first configuration message does not comprise the first field, the first CSI report uses the first reporting type; the first reporting reference type is a candidate type in the first candidate type set, while the first reporting type is a candidate type in the second candidate type set; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

In one subembodiment, the name of the first field in the first configuration message and the name of the reporting type in the first configuration message both include reportQuantity.

In one subembodiment, the first field in the first configuration message is reportQuantity; the reporting type in the first configuration message is a new field in CSI-ReportConfig compared to Release 17 (R17).

In one embodiment, the priority of the first CSI report is:

$$P r {i}_{iCSI} ( y , k , c , s ) = 2 \cdot {N}_{cells} \cdot {M}_{s} \cdot y + {N}_{cells} {M}_{s} \cdot k + {M}_{s} \cdot c + s$$

where the first parameter is the K determined based on the first reporting reference type; when a CSI report indicated by the first reporting reference type includes L1-RSRP or L1-SINR, the first parameter is 0; when a CSI report indicated by the first reporting reference type does not include L1-RSRP or L1-SINR, the first parameter is 1; the priority of the first CSI report and the first parameter are linearly related.

In one embodiment, the first receiver 1601 receives reference signals in at least one RS resource set;
herein, each RS resource set of the at least one RS resource set comprises at least one RS resource, and any CSI report in the first CSI report group is based on a measurement of one RS resource set of the at least one RS resource set.

In one embodiment, any configuration message of the at least one configuration message includes a transmission mode, where candidates for the transmission mode include periodic, semi-persistent and aperiodic; any configuration message of the at least one configuration message explicitly or implicitly indicates a cell index, the cell index indicating a cell occupied by an RS resource set indicated by the corresponding configuration message.

In one embodiment, the first node 1600 is a UE.

In one embodiment, the first transmitter 1602 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In one embodiment, the first transmitter 1602 comprises the antenna 452, the transmitter/receiver 454, the multi-antenna transmitting processor 457, the transmitting processor 468, the controller/processor 459, the memory 460 and the data source 467 in FIG. 4 of the present application.

In one embodiment, the first receiver 1601 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first three of the antenna 452, the receiver 454, the multi-antenna receiving processor 458, the receiving processor 456, the controller/processor 459, the memory 460 and the data source 467 in FIG. 4 of the present application.

### Embodiment 11

Embodiment 11 illustrates a structure block diagram of a processing device used in a second node according to one embodiment of the present application, as shown in FIG. 11. In FIG. 11, a processing device 1700 in a second node is comprised of a second transmitter 1701 and a second receiver 1702.

The second transmitter 1701 transmits a first configuration message group, the first configuration message group comprising at least one configuration message, any configuration message of the at least one configuration message comprising a first-type identifier and a reporting type, the first-type identifier being used to identify the configuration message to which the first-type identifier belongs; the second receiver 1702 receives a first CSI report group, the first CSI report group comprising at least one CSI report, any CSI report in the first CSI report group being configured by a configuration message in the first configuration message group.

In Embodiment 11, any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

In one embodiment, whether the first field is included in the first configuration message is related to the reporting type indicated by the first configuration message; when the reporting type indicated by the first configuration message is a candidate type in a first candidate type set, the first field is not included in the first configuration message; when the reporting type indicated by the first configuration message is a candidate type in a second candidate type set, the first field is included in the first configuration message; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

In one embodiment, the above method is characterized in that when the first configuration message does not comprise the first field, the priority of the first CSI report is a first reference priority; when the first configuration message comprises the first field, the priority of the first CSI report is a first revision priority; the first revision priority is linearly related to the first parameter; a linear coefficient of the priority of the first CSI report to the first parameter is configurable, or, a linear coefficient of the priority of the first CSI report to the first parameter is fixed.

In one embodiment, the reporting type of the first configuration message indicates a first reporting type; when the first configuration message comprises the first field, the first field in the first configuration message indicates a first reporting reference type, the first CSI report using one of the first reporting type or the first reporting reference type, the first parameter being associated with the first reporting reference type; when the first configuration message does not comprise the first field, the first CSI report uses the first reporting type.

In one embodiment, the first reporting reference type is a candidate type in the first candidate type set, while the first reporting type is a candidate type in the second candidate type set; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

In one embodiment, the second transmitter 1701 transmits reference signals in at least one RS resource set;
herein, each RS resource set of the at least one RS resource set comprises at least one RS resource, and any CSI report in the first CSI report group is based on a measurement of one RS resource set of the at least one RS resource set.

In one embodiment, any configuration message of the at least one configuration message includes a transmission mode, where candidates for the transmission mode include periodic, semi-persistent and aperiodic; any configuration message of the at least one configuration message explicitly or implicitly indicates a cell index, the cell index indicating a cell occupied by an RS resource set indicated by the corresponding configuration message.

In one embodiment, the second node 1700 is a UE.

In one embodiment, the second node 1700 is a base station.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second receiver 1702 comprises the antenna 420, the receiver 418, the multi-antenna receiving processor 472, the receiving processor 470, and the controller/processor 475.

In one embodiment, the second receiver 1702 comprises the controller/processor 475.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals. Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first configuration message group, the first configuration message group comprising at least one configuration message, any configuration message of the at least one configuration message comprising a first-type identifier and a reporting type, the first-type identifier being used to identify the configuration message to which the first-type identifier belongs; and
a first transmitter, transmitting a first CSI report group, the first CSI report group comprising at least one CSI report, any CSI report in the first CSI report group being configured by a configuration message in the first configuration message group;
wherein any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

2. The first node according to claim 1, characterized in that whether the first field is included in the first configuration message is related to the reporting type indicated by the first configuration message; when the reporting type indicated by the first configuration message is a candidate type in a first candidate type set, the first field is not included in the first configuration message; when the reporting type indicated by the first configuration message is a candidate type in a second candidate type set, the first field is included in the first configuration message; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

3. The first node according to claim 1, characterized in that when the first configuration message does not comprise the first field, the priority of the first CSI report is a first reference priority; when the first configuration message comprises the first field, the priority of the first CSI report is a first revision priority; the first revision priority is linearly related to the first parameter.

4. The first node according to claim 3, characterized in that a linear coefficient of the priority of the first CSI report to the first parameter is configurable, or, a linear coefficient of the priority of the first CSI report to the first parameter is fixed.

5. The first node according to claim 1, characterized in that the reporting type of the first configuration message indicates a first reporting type; when the first configuration message comprises the first field, the first field in the first configuration message indicates a first reporting reference type, the first CSI report using one of the first reporting type or the first reporting reference type, the first parameter being associated with the first reporting reference type; when the first configuration message does not comprise the first field, the first CSI report uses the first reporting type.

6. The first node according to claim 5, characterized in that the first reporting reference type is a candidate type in the first candidate type set, while the first reporting type is a candidate type in the second candidate type set; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

7. The first node according to claim 1, characterized in comprising:
the first receiver, receiving reference signals in at least one RS resource set;
wherein each RS resource set of the at least one RS resource set comprises at least one RS resource, and any CSI report in the first CSI report group is based on a measurement of one RS resource set of the at least one RS resource set.

8. The first node according to claim 1, characterized in that any configuration message of the at least one configuration message includes a transmission mode, where candidates for the transmission mode include periodic, semi-persistent and aperiodic; any configuration message of the at least one configuration message explicitly or implicitly indicates a cell index, the cell index indicating a cell occupied by an RS resource set indicated by the corresponding configuration message.

9. A second node for wireless communications, comprising:
a second transmitter, transmitting a first configuration message group, the first configuration message group comprising at least one configuration message, any configuration message of the at least one configuration message comprising a first-type identifier and a reporting type, the first-type identifier being used to identify the configuration message to which the first-type identifier belongs; and
a second receiver, receiving a first CSI report group, the first CSI report group comprising at least one CSI report, any CSI report in the first CSI report group being configured by a configuration message in the first configuration message group;
wherein any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

10. The second node according to claim 9, characterized in that whether the first field is included in the first configuration message is related to the reporting type indicated by the first configuration message; when the reporting type indicated by the first configuration message is a candidate type in a first candidate type set, the first field is not included in the first configuration message; when the reporting type indicated by the first configuration message is a candidate type in a second candidate type set, the first field is included in the first configuration message; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

11. The second node according to claim 9, characterized in that when the first configuration message does not comprise the first field, the priority of the first CSI report is a first reference priority; when the first configuration message comprises the first field, the priority of the first CSI report is a first revision priority; the first revision priority is linearly related to the first parameter.

12. The second node according to claim 11, characterized in that a linear coefficient of the priority of the first CSI report to the first parameter is configurable, or, a linear coefficient of the priority of the first CSI report to the first parameter is fixed.

13. The second node according to claim 9, characterized in that the reporting type of the first configuration message indicates a first reporting type; when the first configuration message comprises the first field, the first field in the first configuration message indicates a first reporting reference type, the first CSI report using one of the first reporting type or the first reporting reference type, the first parameter being associated with the first reporting reference type; when the first configuration message does not comprise the first field, the first CSI report uses the first reporting type.

14. The second node according to claim 13, characterized in that the first reporting reference type is a candidate type in the first candidate type set, while the first reporting type is a candidate type in the second candidate type set; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

15. The second node according to claim 9, characterized in comprising:
the second transmitter, transmitting reference signals in at least one RS resource set;
wherein each RS resource set of the at least one RS resource set comprises at least one RS resource, and any CSI report in the first CSI report group is based on a measurement of one RS resource set of the at least one RS resource set.

16. The second node according to claim 9, characterized in that any configuration message of the at least one configuration message includes a transmission mode, where candidates for the transmission mode include periodic, semi-persistent and aperiodic; any configuration message of the at least one configuration message explicitly or implicitly indicates a cell index, the cell index indicating a cell occupied by an RS resource set indicated by the corresponding configuration message.

17. A method in a first node for wireless communications, comprising:
receiving a first configuration message group, the first configuration message group comprising at least one configuration message, any configuration message of the at least one configuration message comprising a first-type identifier and a reporting type, the first-type identifier being used to identify the configuration message to which the first-type identifier belongs; and
transmitting a first CSI report group, the first CSI report group comprising at least one CSI report, any CSI report in the first CSI report group being configured by a configuration message in the first configuration message group;
wherein any CSI report in the first CSI report group is associated with a corresponding priority, one priority being used to determine at least one of whether a corresponding CSI report is updated or whether a corresponding CSI report is transmitted; the priority of a first CSI report is related to whether a first configuration message comprises a first field, the first CSI report is any CSI report in the first CSI report group, and the first configuration message is a configuration message used to configure the first CSI report in the first configuration message group; when the first configuration message comprises the first field, a first parameter is used to determine the priority of the first CSI report, the first parameter being indicated by the first field in the first configuration message; when the first configuration message does not comprise the first field, the first parameter is not used to determine the priority of the first CSI report.

18. The method in the first node according to claim 17, characterized in that whether the first field is included in the first configuration message is related to the reporting type indicated by the first configuration message; when the reporting type indicated by the first configuration message is a candidate type in a first candidate type set, the first field is not included in the first configuration message; when the reporting type indicated by the first configuration message is a candidate type in a second candidate type set, the first field is included in the first configuration message; the first candidate type set includes at least one of cri-RI-PMI-CQI, cri-RI-il, cri-RI-il-CQI, cri-RI-CQI, cri-RSRP, cri-SINR, ssb-Index-RSRP, ssb-Index-SINR, or cri-RI-LI-PMI-CQI; the second candidate type set includes at least one candidate type that does not belong to the first candidate type set.

19. The method in the first node according to claim 17, characterized in that when the first configuration message does not comprise the first field, the priority of the first CSI report is a first reference priority; when the first configuration message comprises the first field, the priority of the first CSI report is a first revision priority; the first revision priority is linearly related to the first parameter.

20. The method in the first node according to claim 19, characterized in that a linear coefficient of the priority of the first CSI report to the first parameter is configurable, or, a linear coefficient of the priority of the first CSI report to the first parameter is fixed.
